(19) United States
(12) Patent Application Publication
(10) Pub. No.: US 2009/0194958 A1
(43) Pub. Date: Aug. 6, 2009

(54) Cart For Folding Chairs

(76) Inventors: Mei Chuen Lin, Taoyuan (TW); Tzu Mei Wang, Taoyuan (TW)

Correspondence Address: RABIN & Berdo, PC, 1101 14TH STREET, NW, SUITE 500, WASHINGTON, DC, 20005, US

(21) Appl. No.: 12/024,286

(22) Filed: Feb. 1, 2008

(51) Int. Cl. B62B 3/10

(52) U.S. Cl. 280/47.35

(57) ABSTRACT

A cart for folding chairs includes a frame having a base and a plurality of frame pieces. The base includes at least two racks having a plurality of notches. The notches on the racks are corresponding to each other. Legs of the folding chairs are received in the notches, thereby holding the folding chairs vertical and closely adjacent to and parallel to each other. The base may further include at least two grooves to receive the racks. Moreover, for the convenience of loading and unloading the folding chairs, at least one of the frame pieces in a lengthwise direction is configured as a removable piece. The opposing frame pieces in a widthwise direction include pads to prevent the folding chairs from bumping into the frame pieces.

### BACKGROUND OF THE INVENTION

1. Field of the Invention

The present invention relates generally to a cart for folding chairs, and in particular to a cart for accommodating and transporting folding chairs.

2. The Prior Arts

Folding chairs are usually placed in corrugated boxes to transport. However, this transportation method is only good for long distance transportation, such as container ships or trucks. It is not suitable to move the folding chairs from one place the other place after use. Thus, a cart is proposed to accommodate and transport the folding chairs. A conventional cart for folding chairs only includes a base and two frame pieces disposed at both sides thereof. The frame pieces work as a handle to pull or push the cart. There are two arrangements to accommodate the folding chairs. A vertical arrangement is to lean a first chair on one of the frame piece, a second chair on the first chair, a third chair on the second chair, and so on. Then the last chair is leaned on the other frame piece. The second arrangement is to place the folding chairs horizontally on the base and pile them up. The cart can accommodate several piles of the folding chairs. No matter which way to accommodate the folding chairs, the conventional cart lacks a fence bars to confine the folding chairs in the cart. When the cart moves on a bumpy floor, vibration will result in collapse of the folding chairs and even making the folding chairs falling off from the cart. Although the conventional cart can carry or store a lot of the folding chairs, it has to be carefully handled to prevent the folding chairs from falling off from the cart.

In order to overcome the disadvantage mentioned above, a cart for folding chairs as shown in FIG. 8 is proposed. The cart includes a base A and frame pieces B. The base A includes a plurality of U-shaped elongated grooves C parallel to each other. The folding chairs are folded and loaded on the cart. The way to load the folding chairs on the cart is to lean a first chair on one of the horizontal frame piece B, front legs and rear legs of the folding chairs are received in the grooves C. Then a second chair, a third chair, etc. are placed on the cart side by side, the front legs and the rear legs are received in the grooves C, until the last chair leans on the other horizontal frame piece B. The cart has the grooves C to receive the front legs and the rear legs, which prevents the folding chairs from falling off from the cart. However, after the folding chair is folded, the length of the front leg is different from that of the rear leg. When the folding chairs are loaded on the cart, only ends of the front legs and rear legs are received in the grooves C. The other parts of the folding chairs are not fixed and kept stationary. Therefore, during short distance transportation by pushing or long distance transportation by a truck or a container ship, bumpy roads or sea will rock the folding chairs on the carts, which results in unfolding the chairs. Once the front legs and the rear legs are unfolded, the cart is unable to accommodate the fold chairs in order and fix the folding chairs together. Thus, the folding chairs are likely to fall off from the cart and damage.

### SUMMARY OF THE INVENTION

A primary objective of the present invention is to provide a cart for folding chairs, which overcomes the disadvantage of the convention design that can not effectively hold the folding chairs in place or prevent the folding chairs from unfolding, leaning over or falling off from the cart. Another objective of the present invention is to provide a cart that holds the folding chairs vertical and confines the folding chairs in the cart and prevents the folding chairs from falling off the cart.

For achieving the aforementioned objectives, a cart for folding chairs according to the present invention includes a frame. A base of the frame includes at least two racks having a plurality of notches. The racks are parallel to each other. The notches disposed on each rack are corresponding to those disposed on another racks. The folding chair is folded and accommodated in the cart. Front legs and rear legs are received in the notches to hold the folding chairs vertical, side by side, and closely adjacent to and parallel to each other.

The rack is made of an elastic material, such as rubber and PU. The racks are received in grooves on the base of the frame. If the cart accommodates one row of the folding chair, the cart has two grooves. The widths of the grooves are corresponding to the front legs and the rear legs of the folding chair. If the cart accommodates two rows of the folding chairs, the cart has three grooves. The groove disposed at a center is twice as wide as the grooves disposed at the sides so as to receive legs of two folding chairs. The legs of the folding chairs are received in the notches of the racks.

In order to confine the chairs in the cart, the cart includes guarding rails. In order to conveniently put the folding chairs on and off the cart, the guarding rails are configured as removable. In order to reinforce the structure of the cart, the cart includes a central piece at a center of the cart.

In order to prevent the folding chairs from bumping into the frame pieces, the frame pieces include pads.

The cart may be configured as a single tier or as multiple tiers. The multiple-tier cart can carry more folding chairs and therefore saves transportation time.

The cart according to the present invention has the following advantages. First of all, the base of the cart includes racks to receive the front legs and the rear legs and thus the folding chairs are held vertical. Intervals between the adjacent notches are the same. Thus, the folding chairs can be arranged closely and orderly, and can carry more folding chairs in a specific space. The legs of the folding chairs are received in the notches, thereby preventing the folding chairs from unfolding.

Secondly, the cart includes the central piece at the center and the removable guarding rails at the sides, which reinforce the structure of the cart. The folding chairs are confined in the space defined between the central piece and the guarding rails. Therefore, the cart prevents the folding chairs from falling off from the cart during transportation.

Thirdly, the frame piece of the cart includes pads so the cart prevents the folding chairs from bumping into the frame piece. The pads also prevent the folding chair from shaking during transportation.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a perspective view showing a cart for folding chairs according to a first embodiment of the present invention;

FIG. 2 is a partially exploded view showing a cart for folding chairs according to a second embodiment of the present invention;

FIG. 3 is a side view showing the cart according to the second embodiment of the present invention;

FIG. 4 is a perspective view showing the cart according to the second embodiment of the present invention and folding chairs accommodated in the cart;

FIG. 5 is a schematic side view showing a notch of a rack according to the second embodiment of the present invention and legs of the folding chairs received in the notch;

FIG. 6 is a partially exploded view showing the cart according to the second embodiment of the present invention, folding chairs accommodated in the cart and a stationary stand;

FIG. 7 is a schematic view showing a multiple-tier cart according to a third embodiment of the present invention; and

FIG. 8 is a perspective view showing a conventional cart for folding chairs.

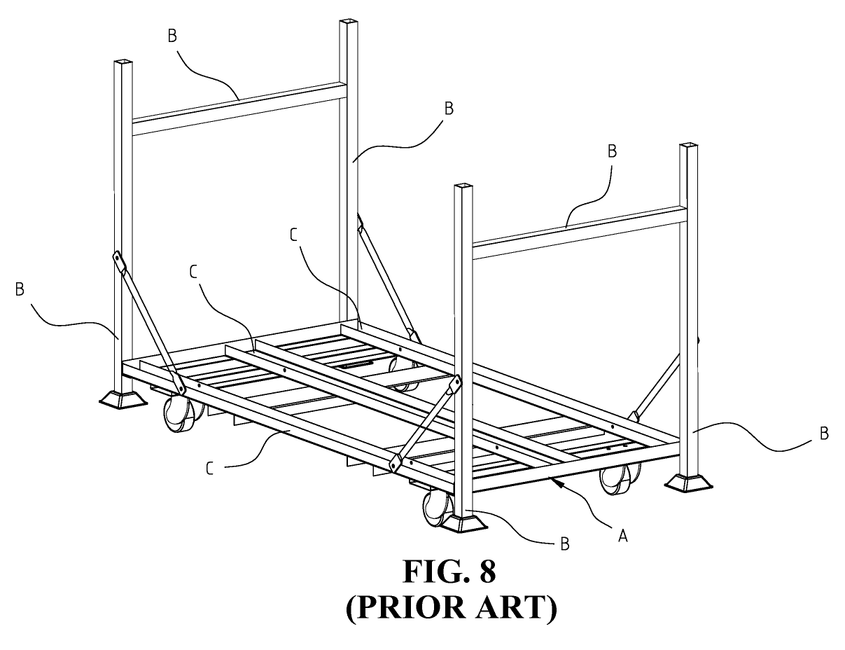

### DETAILED DESCRIPTION OF THE PREFERRED EMBODIMENT

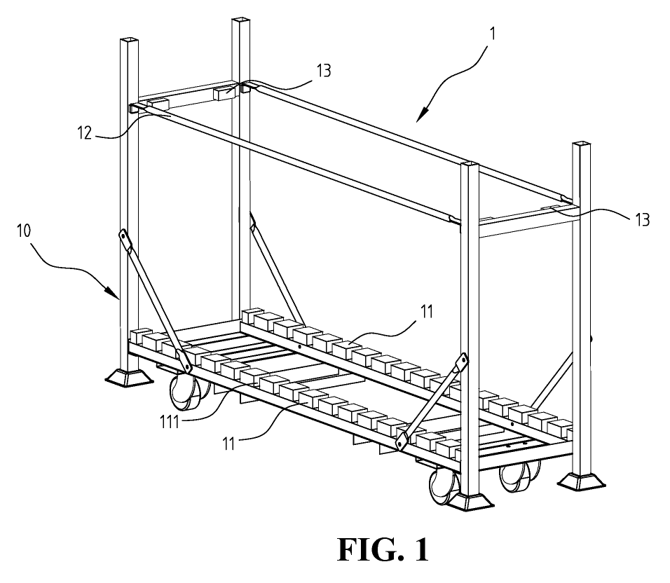

Referring to FIG. 1, a cart 1 for folding chairs according to a first embodiment of the present invention includes a plurality of horizontal frame pieces and vertical frame posts to form a frame 10. A base of the frame 10 includes two racks 11 having a plurality of the notches 111 in a lengthwise direction. The two racks 11 are parallel to each other and the notches 111 on the two racks 11 are corresponding to each other. The notches 111 allow front legs 3 and rear legs 3 of the folding chairs to be received therein. Thus, the folding chairs are held vertical, side by side, and closely adjacent to and parallel to each other. In order to conveniently load the folding chairs on the cart 1 or unloading the folding chairs from the cart 1, at least one of the upper frame pieces in the lengthwise direction is configured as a removable guarding rail 12. Once the guarding rail 12 is removed, the folding chairs can be put on and off from a side of the cart 1. Both the upper frame pieces in a widthwise direction include a plurality of pads 13 to prevent the folding chairs from bumping into the frame pieces. The folding chairs are pressed against the pads 13, thereby preventing the folding chairs from shaking during transportation.

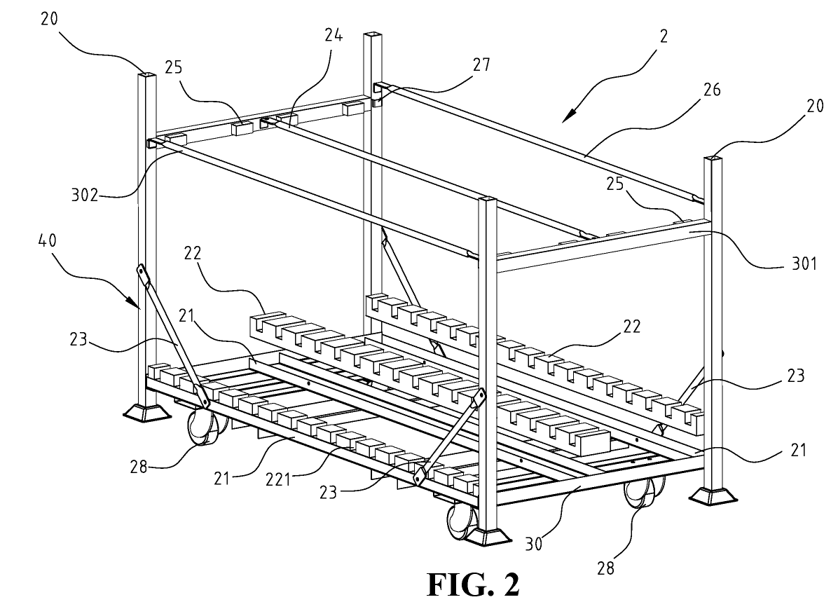

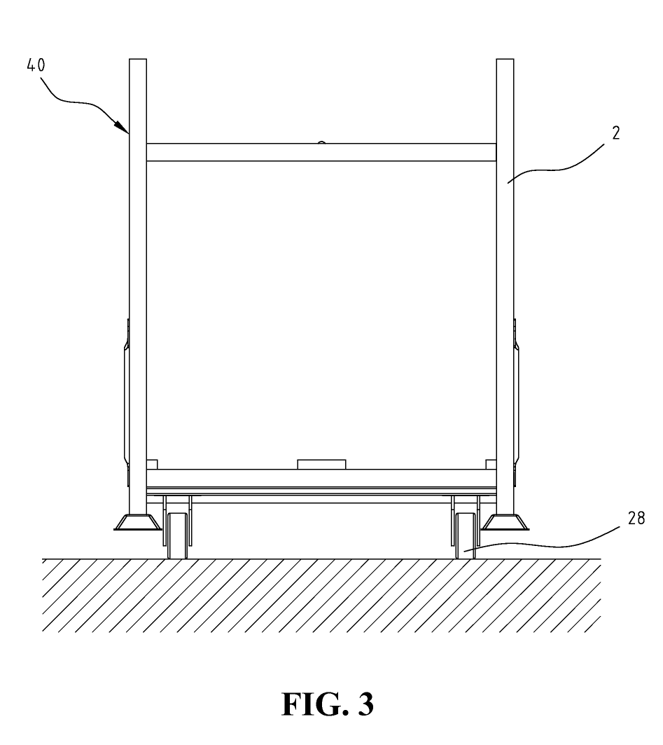

Referring to FIG. 2, a cart 2 for folding chairs according to a second embodiment of the present invention includes four vertical frame posts 20 and a plurality of horizontal frame pieces 30 connected with upper and lower portions of the frame posts 20 to form a frame 40. The upper frame pieces 30 include two first upper frame pieces 301 in a widthwise direction and two second upper frame pieces 302 in a lengthwise direction. The lower frame pieces 30 form a base of the frame 40. The base of the frame 40 includes three elongated U-shaped grooves 21 in the lengthwise direction and parallel to each other. Three racks 22 having a plurality of notches 221 are fitted into the three grooves 21, respectively. The notches 221 on any of the racks 22 are corresponding to those on another rack 22. The racks 22 are made of an elastic material, such as rubber, PU, etc. The frame 40 includes a plurality of slanted struts 23 between the frame posts 20 and the lower frame pieces 30 to reinforce the structure of the frame 40. The frame 40 has a central piece 24 disposed in the lengthwise direction and connected between centers of the first upper frame pieces 301. A plurality of pads 25 are attached on an inner side of the first upper frame piece 301. The second upper frame pieces 302 are configured as removable guarding rails 302. The guarding rail 302 is U-shaped and respectively includes two hooks at both ends thereof. The frame post 20 has a U-shaped piece 27 fixed at a place where the hook of the guarding rail 302 connects with the frame post 20. Thus, when the hooks of the guarding rail 302 connect with the U-shaped pieces 27 on the frame post 20, the guarding rail 302 becomes a movable part of the frame 40. The central piece 24 and the two guarding rails 302 reinforce the structure of the frame 40. The cart 2 includes a plurality of wheels 28 at a bottom thereof. Referring to FIG. 3, the frame 40 does not touch the floor and the cart 2 is supported by the wheels 28. Therefore, it is convenient to move the cart 2.

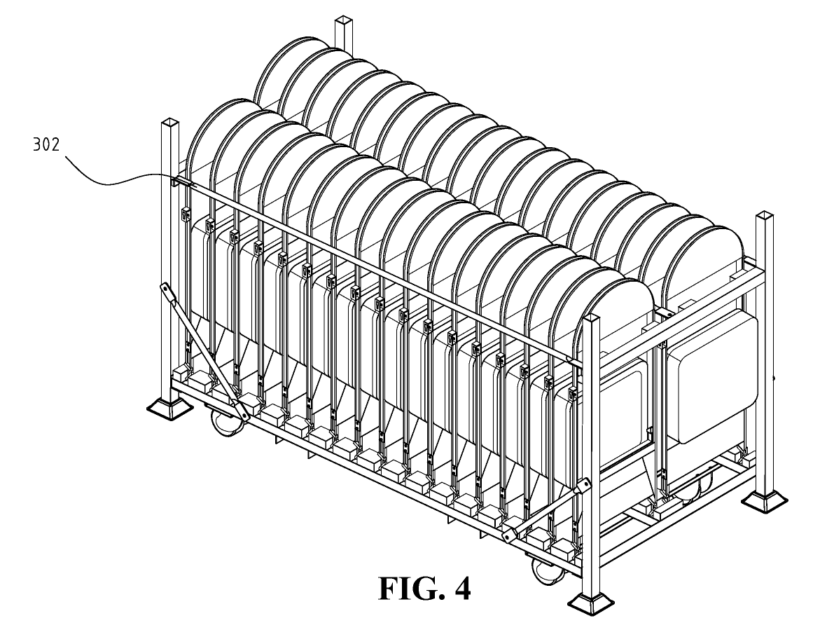

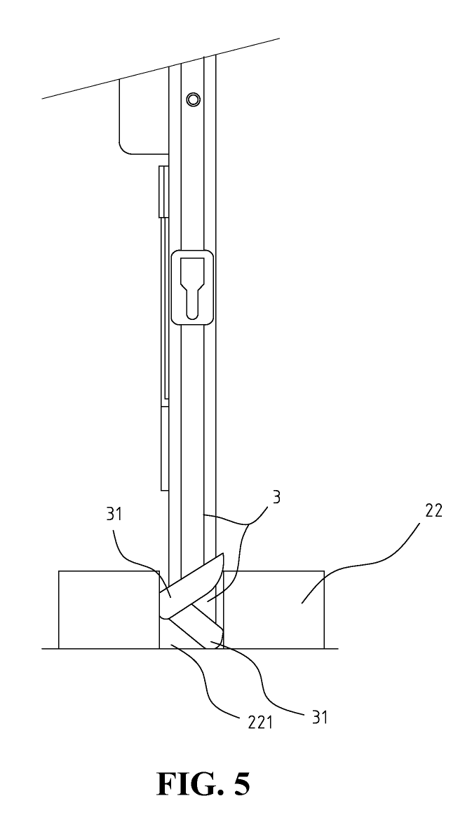

Referring to FIGS. 2 and 4, when loading the folding chairs into the cart 2, the folding chairs are folded, the guarding rails 302 are removed, and the folding chairs are put into the cart 2 from both sides of the cart 2. After the folding chairs are loaded, the guarding rails 302 are connected to the frame posts 20. Referring to FIG. 5, after the folding chairs are folded, the legs 3 are inserted into the notches 221 of the racks 22. Because the length of the front leg 3 is different from that of the rear leg 3, ends 31 of the front leg 3 and the rear leg 3 are pressed against upper and lower portions of the notch 221, respectively. Thus, the notch 221 prevents the front leg 3 from being unfolded from the rear leg 3. Because the rack 22 is made of rubber, the legs 3 are tightly fitted into the notches 221. Thus, the folding chairs are held vertical, side by side, and closely adjacent to and parallel to each other. The cart 2 can accommodate two rows of the folding chairs which are received at both sides of the central piece 24. Thus, the folding chairs are confined between the central piece 24 and the guarding rails 302, thereby preventing the folding chairs from falling off from the cart 2. The pads 25 are pressed against the folding chairs adjacent thereto, thereby preventing the folding chairs from shaking and bumping into the frame 40.

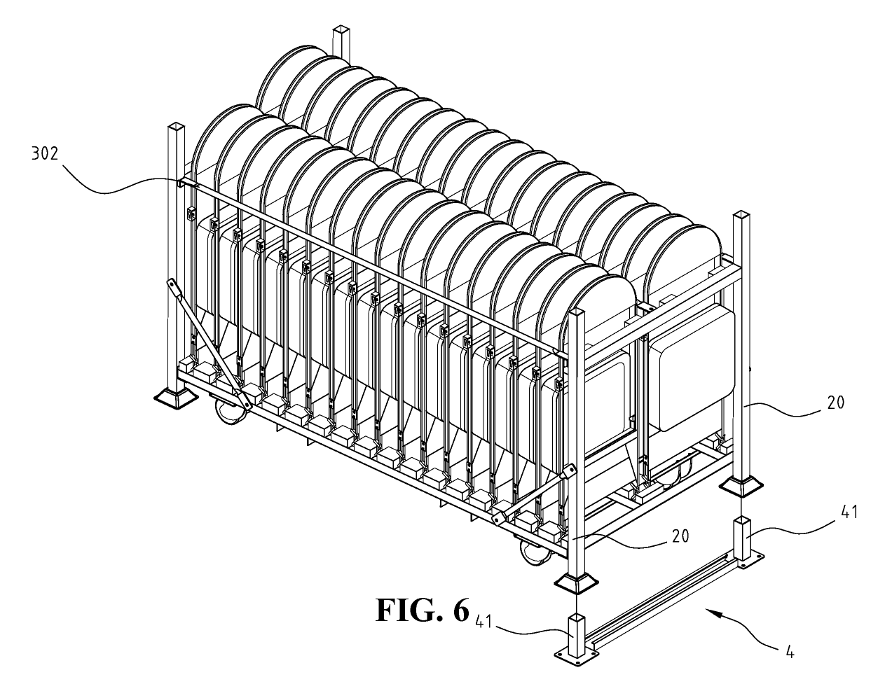

Because the cart 2 is equipped with the wheels 28, it is convenient to move the folding chairs from one place to the other place. However, when the folding chairs are loaded to or unloaded from the cart 2, it needs to keeps the cart 2 stationary. Referring to FIG. 6, the cart further includes a pair of stationary stands 4. The stationary stand 4 includes an elongated rod and two engaging posts 41 respectively connected with both ends of the elongated rod. The length of the elongated rod is corresponding to a distance between the frame posts 20 in the widthwise direction. Lower ends of the frame posts 20 are frusto-pyramid-shaped for easy engagement with the engaging posts 41. The engaging posts 41 are inserted into the lower ends of the frame posts 20 and pressed by the frame posts 20. The stationary stands 4 contact with the floor and support the cart 2. Therefore, the cart 2 is kept stationary on the floor for easy loading and unloading the folding chairs.

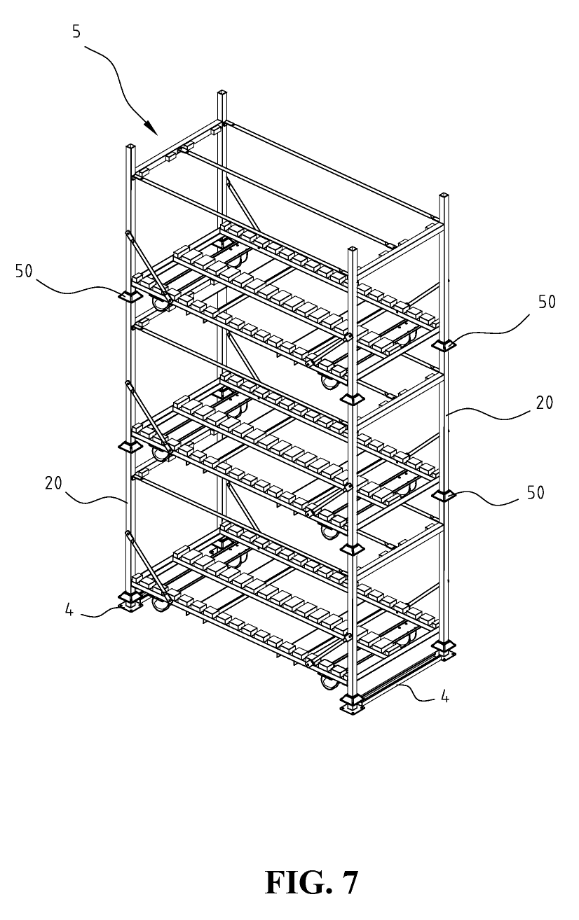

Referring to FIG. 7, a multiple-tier cart 5 according to a third embodiment of the present invention includes a plurality of the single-tier carts as shown in FIGS. 1-6. The lower end of the frame post 20 includes an engaging member 50 to engage with the frame post 20 of the other tier. Thus, the single-tier carts can be piled up to form the multiple-tier cart 5. Because the stationary posts 4 can be installed at the bottom of the cart 5, the cart 5 can be kept stationary. During transportation on the sea, the cart 5 in the container is not affect by roll of the ship and therefore prevents the folding chairs from falling off from the cart 5.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A cart for folding chairs, comprising:
a frame having a base and a plurality of upper frame pieces;
wherein the base comprises at least two racks having a plurality of notches, the notches on the racks are corresponding to each other, and the notches receive legs of the folding chairs, thereby holding the folding chairs vertical, side by side, and closely adjacent to and parallel to each other.

2. The cart according to claim 1, wherein at least one of the upper frame pieces of the frame is configured as a removable piece.

3. The cart according to claim 1, wherein a pair of the opposing upper frame pieces of the frame comprises a plurality of pads disposed at inner sides thereof.

4. The cart according to claim 1, wherein the base of the frame comprises at least two grooves to receive the racks.

5. A cart for folding chairs, comprising:
at least two frames, each of the frames having a base, a plurality of horizontal upper frame pieces and a plurality of vertical frame posts, each of the frame posts comprising an engaging piece at a lower end thereof to engage with an upper end of the other frame post, the frames being piled up by engaging the engaging pieces with the frame posts;
wherein each of the bases comprises at least two racks having a plurality of notches, the notches on the racks are corresponding to each other, and the notches receive legs of the folding chairs, thereby holding the folding chairs vertical, side by side, and closely adjacent to and parallel to each other.

6. The cart according to claim 5, wherein at least one of the upper frame pieces of the frame is configured as a removable piece.

7. The cart according to claim 5, wherein a pair of the opposing upper frame pieces of the frame comprises a plurality of pads disposed at inner sides thereof.

8. The cart according to claim 5, wherein the bases of the frame comprise at least two grooves to receive the racks.
